(19) United States
(12) Patent Application Publication
(10) Pub. No.: US 2014/0308061 A1
(43) Pub. Date: Oct. 16, 2014

(54) Method and System for Detecting Engagement with a Work Tool Accessory

(71) Applicant: Caterpillar Inc., Peoria, IL (US)

(72) Inventor: Troy Curtis Robl, St George, KS (US)

(21) Appl. No.: 13/863,665

(22) Filed: Apr. 16, 2013

(51) Int. Cl. E02F 3/36; G01N 3/20

(52) U.S. Cl. CPC E02F 3/3609; G01N 3/20
USPC 403/11; 73/849

(57) ABSTRACT

The present disclosure is in the field of construction and mining machinery and is directed to a quick coupler, a machine incorporating a quick coupler, and a method for detecting positive engagement between a quick coupler and a work tool accessory. The various embodiments involve detecting the strain exerted on an engagement mechanism of the quick coupler by an attachment mechanism of a work tool accessory or determining the proximity between the engagement mechanism and the attachment mechanism in order to determine if the work tool accessory is positively coupled with the quick coupler.

### TECHNICAL FIELD

This patent disclosure relates generally to construction and mining machinery and, more particularly, to a method and system for detecting positive coupling between a quick coupler and a work tool accessory.

### BACKGROUND OF THE INVENTION

Some quick coupler devices may allow the operator of a construction or mining machine to attach a work tool accessory to the arm of the machine through controls in the operator station of the machine without having to exit the operator station and manually attach the work tool accessory. These quick couplers greatly minimize downtime as the quick coupler may be attached to and detached from a work tool without requiring that a worker remove or attach the work tools by hand. The quick coupler is interposed at the junction between the machine and the work tool accessory. The work tool accessory is attached to the quick coupler, and the quick coupler is attached to the machine. The operator of the machine commands the quick coupler to release a work tool from inside the operator station. The machine is then repositioned to a second work tool accessory, where the operator may then manipulate the quick coupler to pick up the second work tool accessory.

Some quick couplers may rely on two recesses in the quick coupler for receiving a pair of attachment pins of the work tool accessory. An engagement mechanism is associated with one of the recesses for securing one of the attachment pins within one recess. The second attachment pin may be indirectly held within the second recess by the action of the engagement mechanism associated with the first recess. Other quick couplers, as disclosed in U.S. Pat. No. 7,882,898 to Vering, et al., may use a cylinder capable of being received by hooks on a work tool accessory and then at least two wedges that can be extended into and retracted from a wedge pocket on the work tool accessory. The extension of the two wedges may secure the work tool accessory to the machine, while the retraction of the two wedges may release the work tool accessory from the machine.

Some quick couplers where positive coupling with the work tool accessory is monitored are known in the art, but these systems rely on measuring cylinder pressure or cylinder length in respect to a pin on the work tool accessory, which can be inaccurate. The known systems may be dependent on taking multiple measurements to detect proper engagement with the work tool accessory. The need for multiple measurements leads to a higher chance that positive engagement may not be detected or may be falsely detected. The known systems may also be dependent on the pin of the work tool accessory having a predetermined diameter, which will limit the versatility of the machine

### SUMMARY OF THE INVENTION

One aspect of the present disclosure is directed to a quick coupler, where one or more wedge engagement mechanisms are used to secure the work tool accessories to a machine, and a sensor is incorporated into each wedge that can detect the strain exerted on the wedge by the work tool accessory. The sensor may be incorporated into the body of the wedge mechanism for protection damage. When the wedge mechanism engages the work tool attachment mechanism, such as a pin, the wedge mechanism tends to bend slightly when wedge mechanism is forced under the pin. This bending moment is detected by the sensor and thereby reports that the work tool accessory is properly coupled to the quick coupler.

The present disclosure further contemplates a quick coupler where two engagement mechanisms, in the form of wedges, engage two work tool attachment mechanisms on the work tool accessory. The two engagement mechanism may each have a sensor incorporated into the body of the wedge mechanism where the sensor may be able to detect the strain forced on to the wedge during engagement with the work tool attachment mechanism. The sensors may be able to detect a bending moment on the wedge mechanisms or an axial moment. The sensors may then read the strain on the wedge mechanism back to an engine control module or add-on computer to determine if the work tool accessory is positively coupled with the quick coupler.

The present disclosure further contemplates a quick coupler where a proximity sensor may be incorporated into the wedge engagement system used to secure the work tool accessories to a machine. The proximity sensor may detect the distance between the wedge engagement system and the work tool accessory in order to determine positive coupling between the quick coupler and the work tool accessory.

Another aspect of the present disclosure is directed to a method for detecting work tool engagement including the steps of actuating an engagement mechanism, measuring a strain within the engagement mechanism, and determining whether the strain indicates positive coupling with a work tool attachment mechanism.

Another aspect of the present disclosure is directed to a machine having a quick coupler capable of attaching a tool to the machine while detecting whether the quick coupler has positively engaged the tool.

### BRIEF DESCRIPTION OF THE DRAWINGS

FIG. 1 is an illustration of an example machine that may include a quick coupler capable of sensing positive engagement with a work tool accessory by measuring the strain in the engagement mechanism.

FIG. 2 is a side view of an example quick coupler positively coupled with a work tool attachment mechanism.

FIG. 3 is a side view of an example quick coupler negatively coupled with a work tool attachment mechanism.

FIG. 4 is a perspective view of an exemplary engagement mechanism.

FIG. 5 is a cross-sectional side view of quick coupler positively coupled with a work tool attachment mechanism.

FIG. 6 is a perspective view of an exemplary engagement mechanism.

FIG. 7 is a schematic illustration of an exemplary sensor capable of detecting a bending moment in an engagement mechanism.

FIG. 8 is a schematic illustration of another exemplary sensor capable of detecting a bending moment in an engagement mechanism.

FIG. 9 is a side view of an exemplary quick coupler with two engagement mechanisms.

FIG. 10 is a perspective view of an exemplary work tool accessory and a perspective view of the exemplary engagement system of FIG. 9 positively coupled with the exemplary work tool accessory.

FIG. 11 is a schematic illustration of another exemplary sensor capable of detecting a bending moment in an engagement mechanism.

FIG. 12 is a flowchart of an exemplary method that may be used to detect positive coupling between a quick coupler and a work tool accessory.

FIG. 13 is a flowchart of an exemplary method that may be used to detect positive coupling between a quick coupler and a work tool accessory where two different engagement mechanisms couple with two different work tool attachment mechanisms.

### DETAILED DESCRIPTION OF THE INVENTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

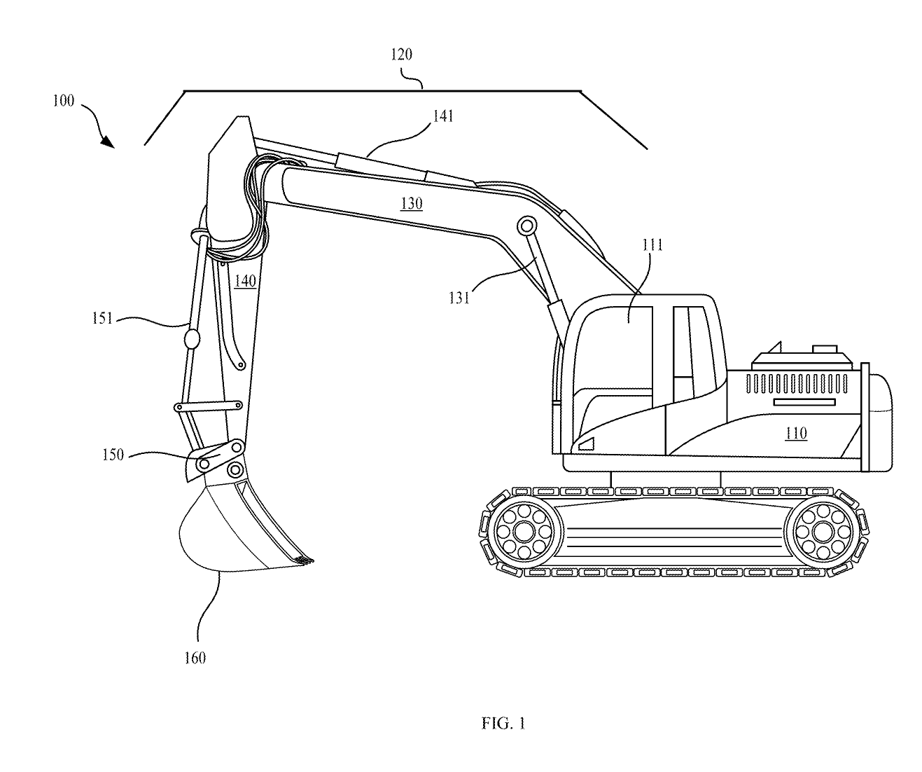

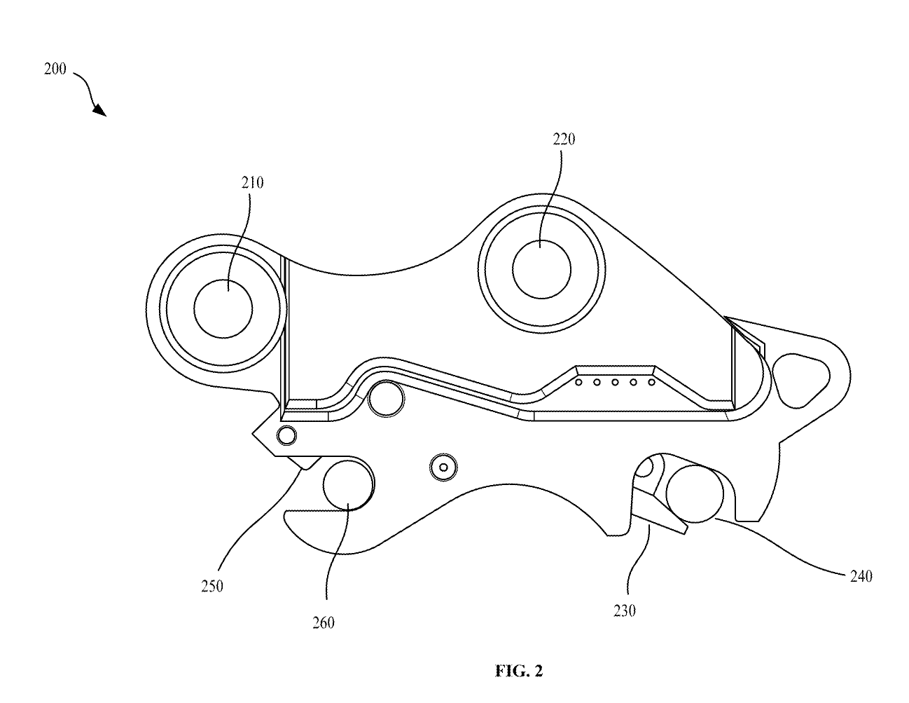

FIG. 1 is an illustration of an exemplary machine 100. Machine 100 may be a fixed or mobile machine that performs some type of operation associated with an industry, such as mining, construction, fainting, transportation, or any other industry known in the art. For example, machine 100 may be an earth moving machine such as an excavator, a backhoe, a loader, or a motor grader. Machine 100 may include a power source 110, a tool system 120 driven by power source 110, and an operator station 111 situated for manual control of tool system 120.

Tool system 120 may include linkage acted on by hydraulic cylinders to move a work tool accessory 160. Specifically, tool system 120 may include a boom member 130 that is vertically pivotal and controlled by first hydraulic mechanisms 131, and a stick member 140 that is vertically pivotal and controlled by a second hydraulic cylinder 141. Tool system 120 may further include a quick coupler 200 that is connected to the stick member 140 and is vertically pivotal and controlled by a third hydraulic cylinder 151. Tool system 120 may further include a work tool accessory 160 that is vertically pivotal and coupled with the quick coupler.

Numerous different work tool accessories 160 may be attachable to a single machine 100 and controllable via operator station 111. Work tool accessory 160 may include any device used to perform a particular task such as, for example, a bucket, a fork arrangement, a blade, a grapple, or any other task-performing device known in the art. Although connected in the embodiment of FIG. 1 to pivot relative to machine 100, work tool accessory 160 may additionally rotate, slide, swing, lift, or move in any other manner known in the art. Work tool accessory 160 may include fore- and aft-located attachment mechanisms, such as tool pins, that facilitate connection to tool system 120 by coupling to quick coupler 200. The quick coupler 200 may include a sensor incorporated into an engagement mechanism that can detect a bending moment within the engagement mechanism. The sensor may then be capable of communicating the measurement of the bending moment to an engine control module to determine if there is positive engagement with the work tool accessory 160. The engine control module may then alert the operator by activating an alarm, which may be visual, audial or both, in the operator station 111 if the bending moment is below or above a predetermined threshold value.

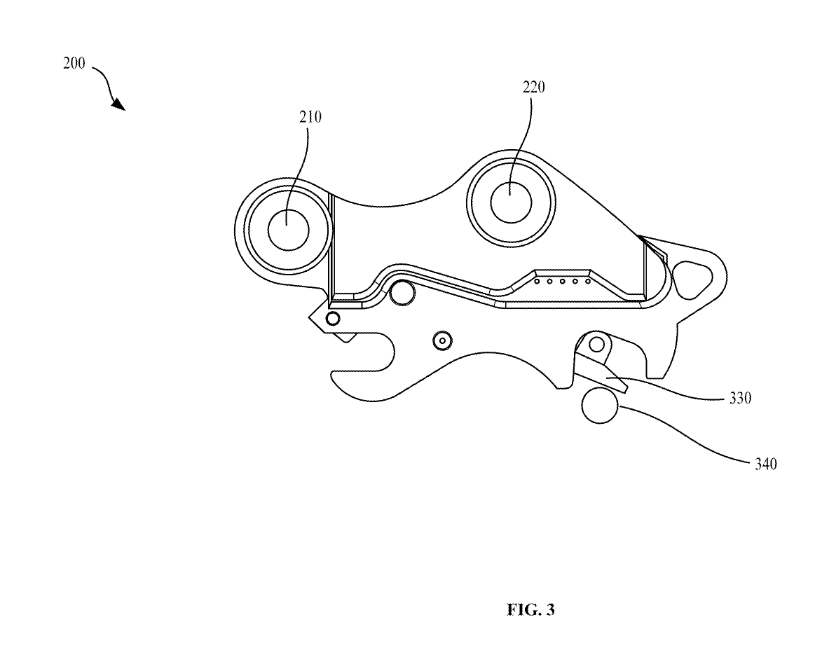

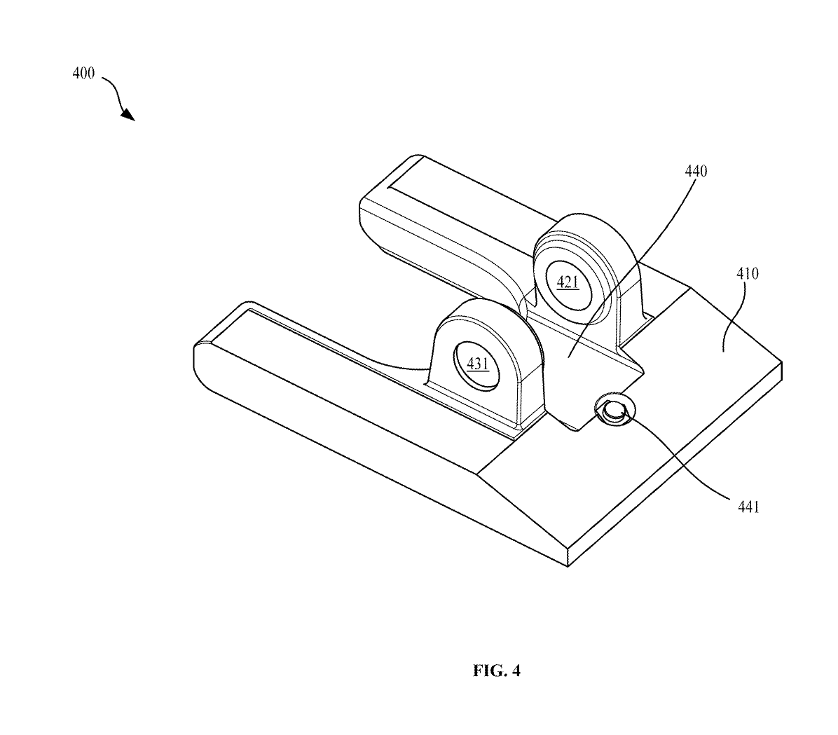

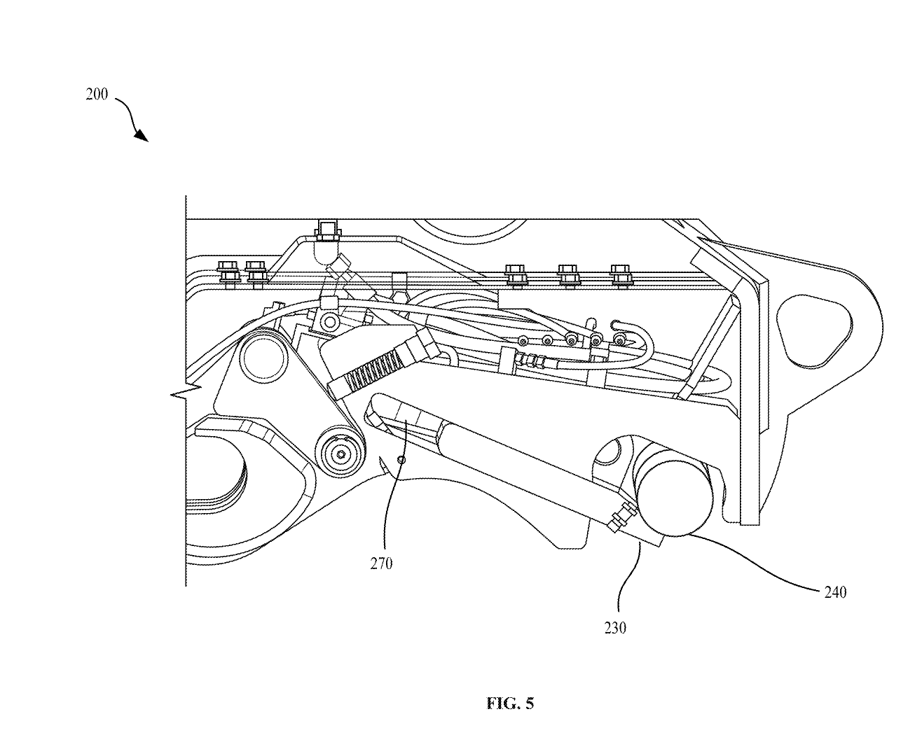

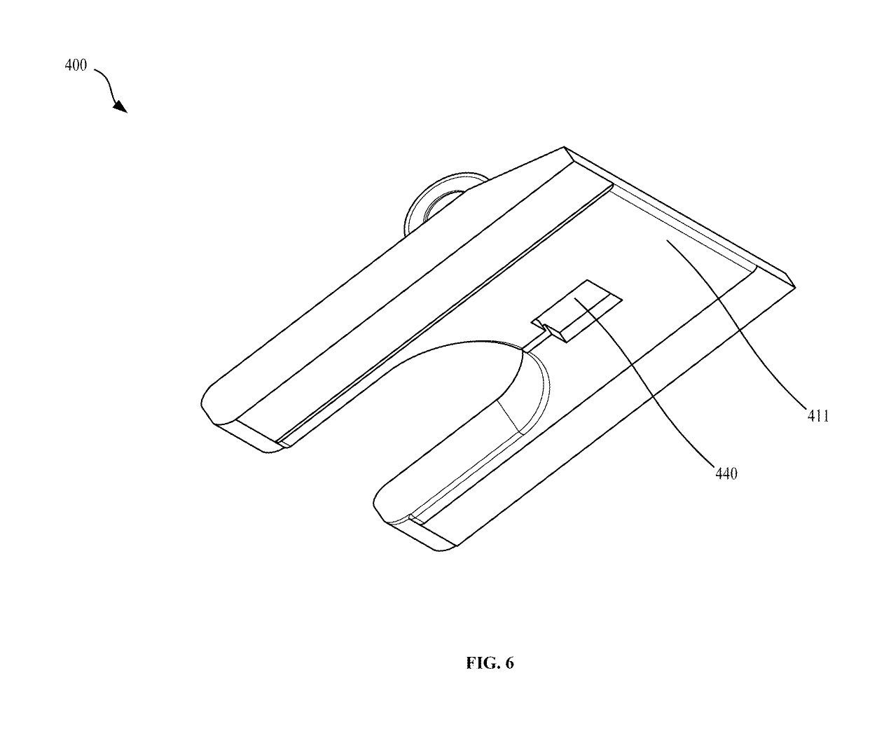

FIG. 2 is a side view of an exemplary quick coupler 200. In FIG. 2 the quick coupler 200 is positively coupled with a first work tool attachment mechanism 240, shown as a cylindrical pin. FIG. 3 depicts an example of negative coupling between the quick coupler 200 and the first work tool attachment mechanism 240. The first engagement mechanism 230 may be a wedge as shown in FIG. 4. The first engagement mechanism 230 may move longitudinally between a recessed configuration proximate to the center of the quick coupler 200 and an extended configuration distal to the center of the quick coupler 200 as shown in FIG. 2, FIG. 3, and FIG. 5. As shown in FIG. 5 the movement of the first engagement mechanism 230 may be connected to a first hydraulic actuator 270.

The quick coupler 200 may be attached to a stick member 140 of a machine 100 at coupler pin openings 210 and 220. The quick coupler 200 may also contain a secondary recess 250 that may couple with a second work tool attachment mechanism 260. In some embodiments a latch or other enclosing mechanism may secure the second work tool attachment mechanism 260 within the secondary recess 250 of the quick coupler 200.

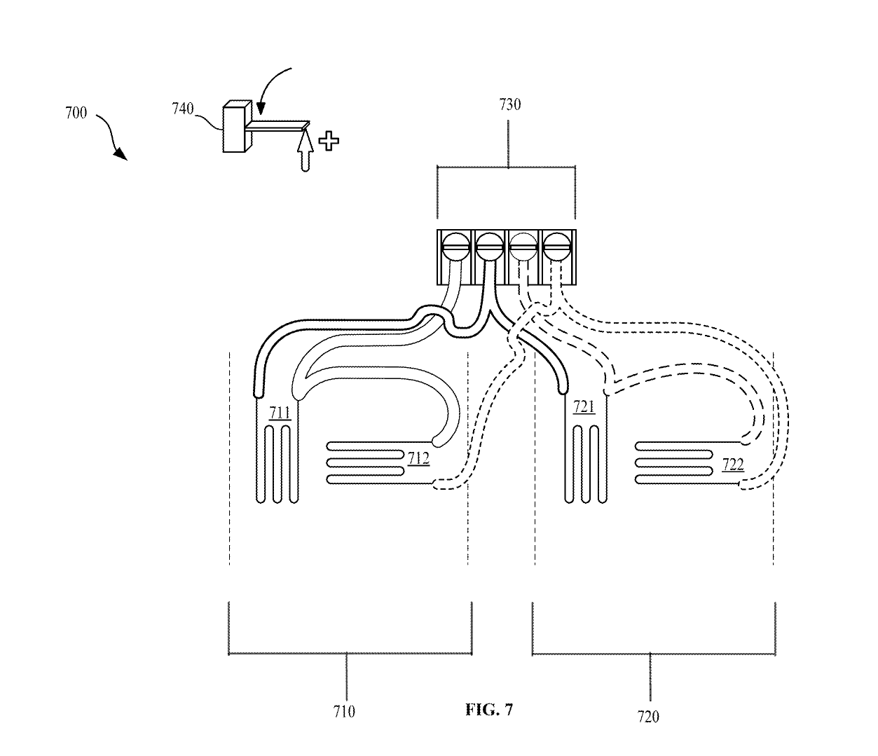

FIG. 4 and FIG. 6 show an exemplary engagement mechanism 230, here shown as a wedge. The engagement mechanism 230 may have engagement mechanism pin openings 231 and 232 that may allow the first engagement mechanism 230 to be coupled with other parts of a quick coupler 200. The first engagement mechanism 230 may have an upper front lip 234 that contacts the first work tool attachment mechanism 240 during positive coupling and bottom front lip 236 that contacts first work tool attachment mechanism 240 during negative coupling. The first engagement mechanism 230 may have a first sensor 233 incorporated in the body of the first engagement mechanism 230. The first sensor 233 may be inserted or removed from the first engagement mechanism 230 by actuating a fastening mechanism 235. The first sensor 233 may detect strain within the engagement mechanism 230 created when the engagement mechanism 230 contacts the work tool attachment mechanism 240. The value of strain may correspond to positive engagement with the work tool attachment mechanism 240 as shown in FIG. 2 or negative engagement with the work tool attachment mechanism 240 as shown in FIG. 3.

The value of the bending moment may be transferred to a central processing unit or an engine control module through a communication system. The central processing unit or engine control unit may determine whether the bending moment is above or below a predetermined threshold value and then may actuate an alarm system.

The first sensor 233 may also detect proximity between the first engagement mechanism 230 and the work tool attachment mechanism 240. The distance between the first engagement mechanism 230 and the work tool attachment mechanism 240 may be determined by the first sensor 233 and may correspond to negative coupling or positive coupling between the quick coupler 200 and the work tool accessory 160. The first sensor 233 may emit an electromagnetic field or a beam of electromagnetic radiation that is affected or returned by the work tool attachment mechanism 240. The first sensor 233 may then detect the change in the electromagnetic field or a beam of electromagnetic radiation or the return signal in order to determine the proximity between the first engagement mechanism 230 and the work tool attachment mechanism 240. The value of the distance between the first engagement mechanism 230 and the work tool attachment mechanism 240 may be transferred to a central processing unit or an engine control module through a communication system. The central processing unit or engine control unit may determine whether the distance is above or below a predetermined threshold value and then may actuate an alarm system.

FIG. 7 is a schematic illustration of an exemplary sensor 700 capable of detecting a bending moment 740 in an engagement mechanism 230. The sensor 700 may include two pairs of strain gages in a full bridge configuration that produces an output reading of the bending moment 740 on the engagement mechanism 230 of the quick coupler 200. The first pair of strain gages 711, 712 may be on a first side 710 and a second pair of strain gages 721, 722 may be on a second side 720. The first side 710 may include a first gage 711 and a second gage 712 that are positioned perpendicular to each other where one gage is in the principal direction to measure bending strain and one gage is in the transverse direction to compensate for temperature. The second side 720 of the exemplary sensor 700 may include a third gage 721 and a fourth gage 722 also positioned perpendicular to each other, where one gage is in the principal direction and used to measure bending and the other gage is in the transverse direction and used for temperature compensation.

The exemplary sensor 700 may also contain a voltage source 730 capable of transmitting voltage to gages 711, 712, 721, and 722. The exemplary sensor 700 may be capable of reading measurements into an engine control module or add-on central processing unit through wiring means. Other sensors may use wireless communication mechanisms to read measurements into an engine control module or add-on central processing unit.

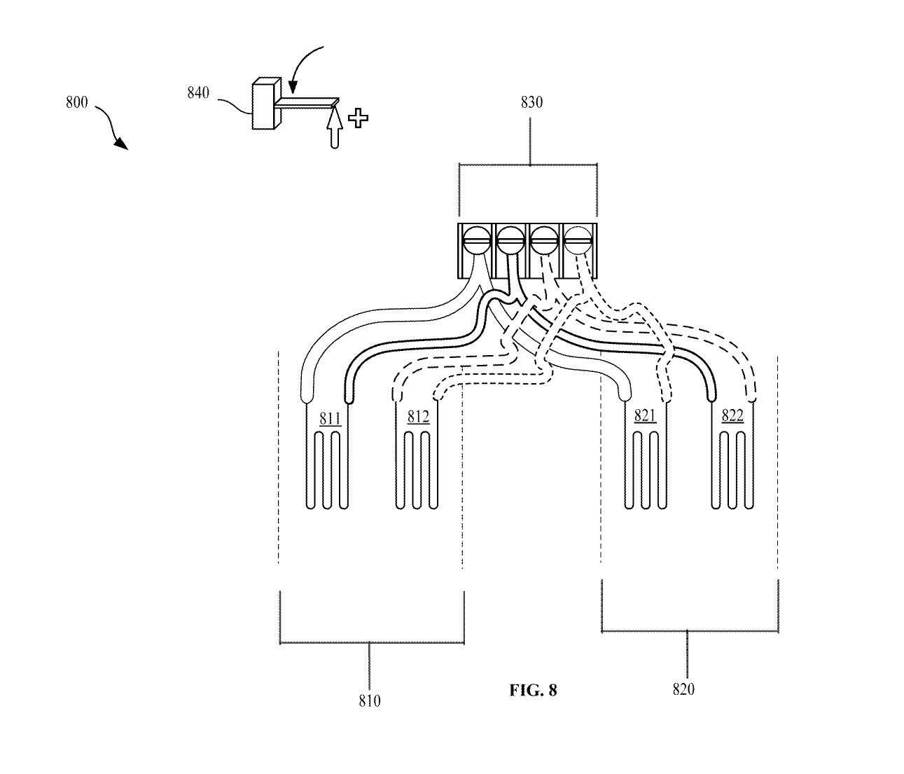

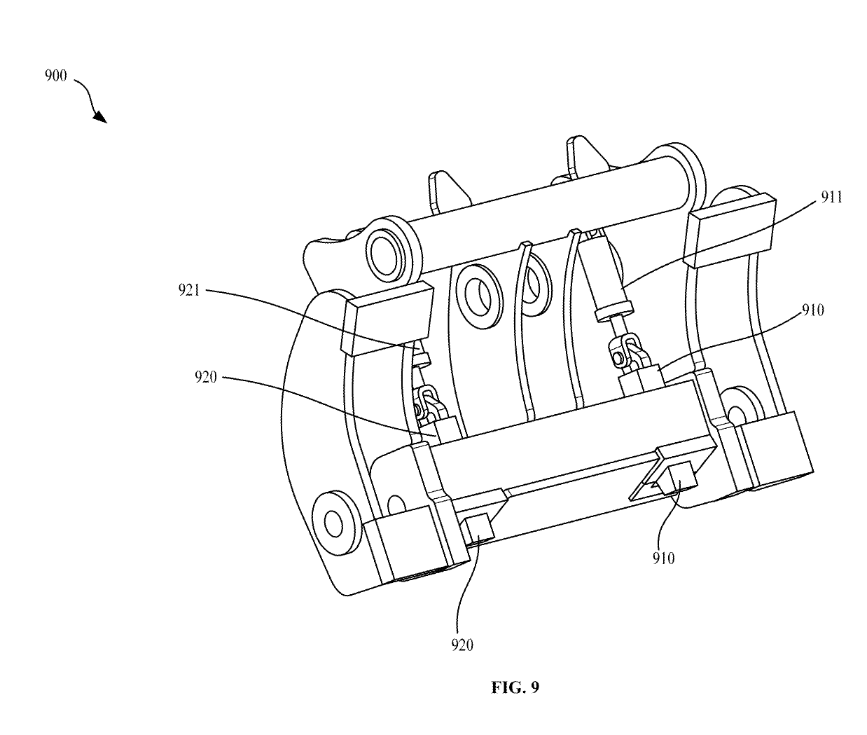

FIG. 8 is a schematic illustration of an exemplary sensor 800 capable of detecting a bending moment 840 in an engagement mechanism 230. The sensor 800 may include two pairs of strain gages in a full bridge configuration that produces an output reading of the bending moment 840 on the engagement mechanism 230 of the quick coupler 200. The first pair of strain gages 811, 812 may be on a first side 810 and a second pair of strain gages 821, 822 may be on a second side 820. The first side 810 may include a first gage 811 and a second gage 812 that are positioned parallel to each other where each gage is in the principal direction and used to measure bending strain. The second side 820 of the exemplary sensor 800 may include a first gage 821 and a second gage 822 also positioned parallel to each other, where each gage is in the principal direction and used to measure bending strain.

The exemplary sensor 800 may also contain a voltage source 830 capable of transmitting voltage to gages 811, 812, 821, and 822. The exemplary sensor 800 may be capable of measuring the bending moment 840 at a higher resolution than exemplary sensor 700 in FIG. 7. The exemplary sensor 800 may be capable of reading measurements into an engine control module or add-on central processing unit through wiring means. Other sensors may use wireless communication mechanisms to read measurements into an engine control module or add-on central processing unit.

The present disclosure also contemplates sensors using a multitude of other configurations of gages. This may include quarter bridge, half bridge, and full bridge configurations of gages where the gages are oriented to measure tensile, compression, and/or bending strain on the engagement mechanism.

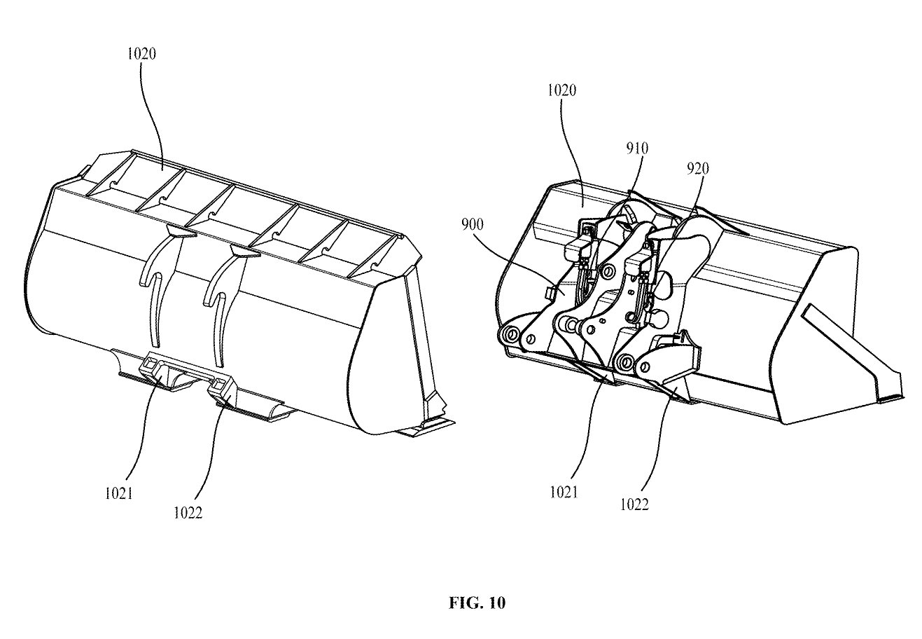

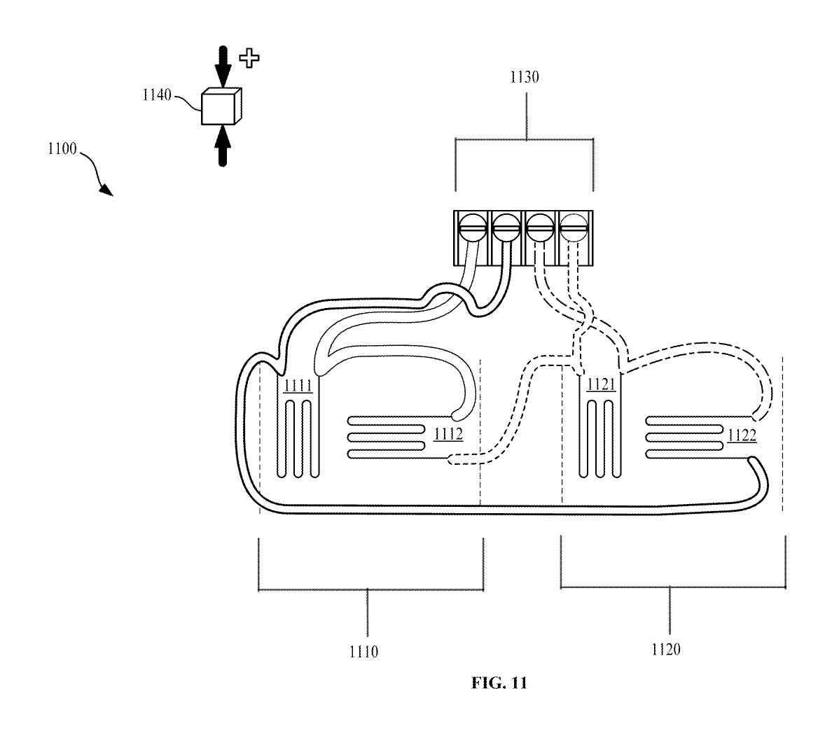

FIGS. 9 and 10 show another exemplary quick coupler 900 where a first engagement mechanism 910 and a second engagement mechanism 920 are controlled by a first hydraulic actuator 911 and a second hydraulic actuator 921 respectively. The quick coupler 900 may couple with a work tool accessory 1020. Coupling may occur when the first engagement mechanism 910 couples with the first work tool attachment mechanism 1021 and second engagement mechanism 920 couples with second work tool attachment mechanism 1022. A have a first sensor may be incorporated in to the body of the first engagement mechanism 910 and a second sensor may be incorporated into the body of the second engagement mechanism 920. The first and second sensor may be capable of determining a bending moment or axial moment in the first engagement mechanism 910 and second engagement mechanism 920 respectively. The value of the bending moment or axial moment may be transferred to a central processing unit or an engine control module through a communication system. The central processing unit or engine control unit may determine whether the bending moment is above or below a predetermined threshold value and then may actuate an alarm system.

FIG. 11 is a schematic illustration of another exemplary sensor 1100 capable of detecting an axial moment 1140 in an engagement mechanism 910, 920. The sensor 1100 may include two pairs of strain gages 1111, 1112, 1121, 1122 in a full bridge configuration that produces an output reading of the axial moment 1140 on the engagement mechanisms 910, 920 of the quick coupler 900. The first pair of strain gages 1111, 1112 may be on a first side 1110 and a second pair of strain gages 1121, 1122 may be on a second side 1120. The first side 1110 may include a first gage 1111 and a second gage 1112 that are positioned perpendicular to each other where one gage is in the principal direction to measure compression or tensile strain and one gage is in the transverse direction to compensate for temperature. The second side 1120 of the exemplary sensor 1100 may include a third gage 1121 and a fourth gage 1122 also positioned perpendicular to each other, where one gage is in the principal direction and used to measure tension and compression and the other gage is in the transverse direction and used for temperature compensation.

The exemplary sensor 1100 may also contain a voltage source 1130 capable of transmitting voltage to gages 1111, 1112, 1121, and 1122. The exemplary sensor 1100 may be capable of reading measurements into an engine control module or add-on central processing unit through wiring means. Other sensors may use wireless communication mechanisms to read measurements into an engine control module or add-on central processing unit.

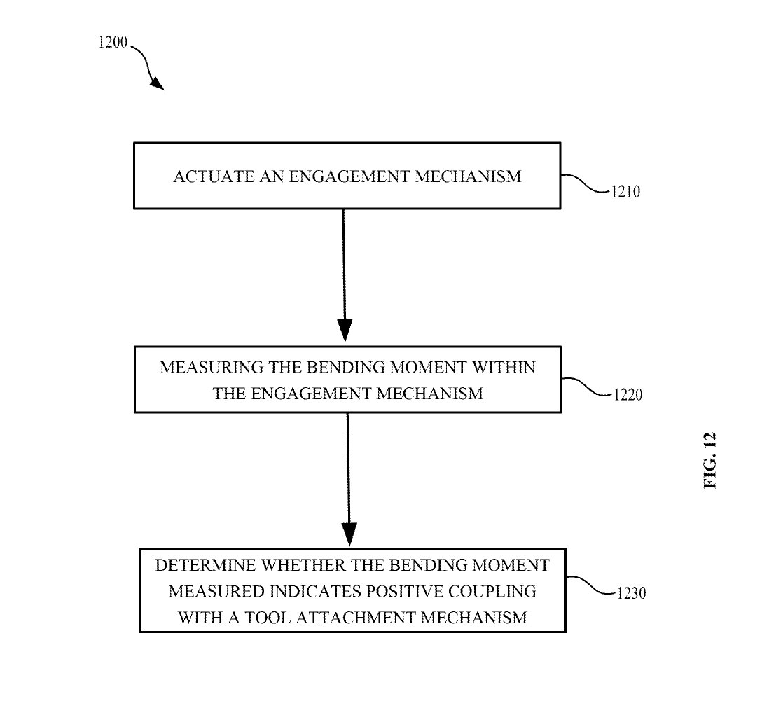

FIG. 12 is a flowchart of an exemplary method 1200 that may be used to detect positive coupling between a quick coupler and a work tool accessory. The exemplary method 1200 may involve actuating a first engagement mechanism 1210. The first engagement mechanism may be actuated through a hydraulic actuator controlled by an operator. The exemplary method may also involve measuring the strain within the first engagement mechanism 1220. The strain may be a bending moment or axial moment within the first engagement mechanism. The exemplary method may also involve determining whether the value of the strain within the first engagement mechanism indicates positive coupling with a first work tool attachment mechanism 1230. The exemplary method 1200 may also involve actuating an alarm if the strain does not indicate positive coupling between the first engagement mechanism and the first work tool attachment mechanism.

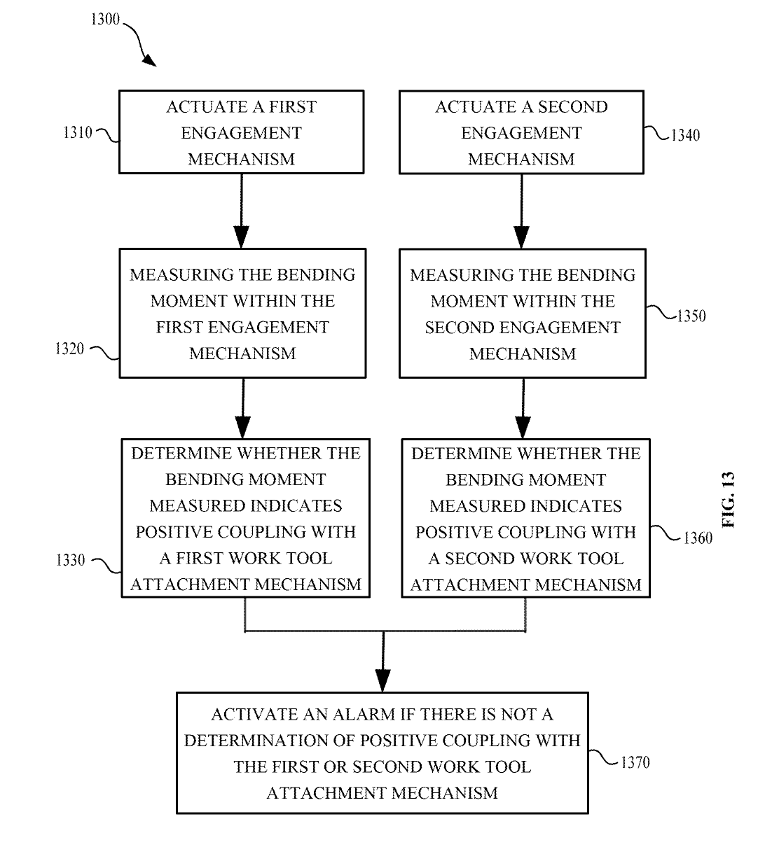

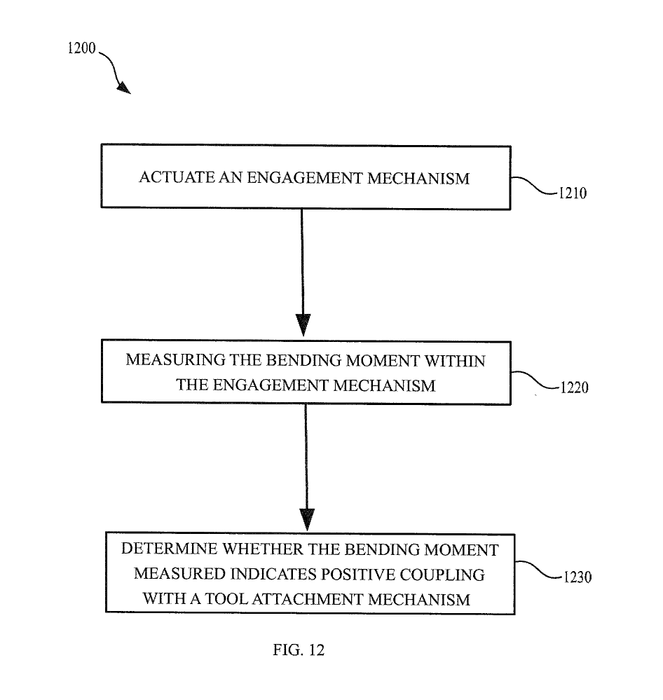

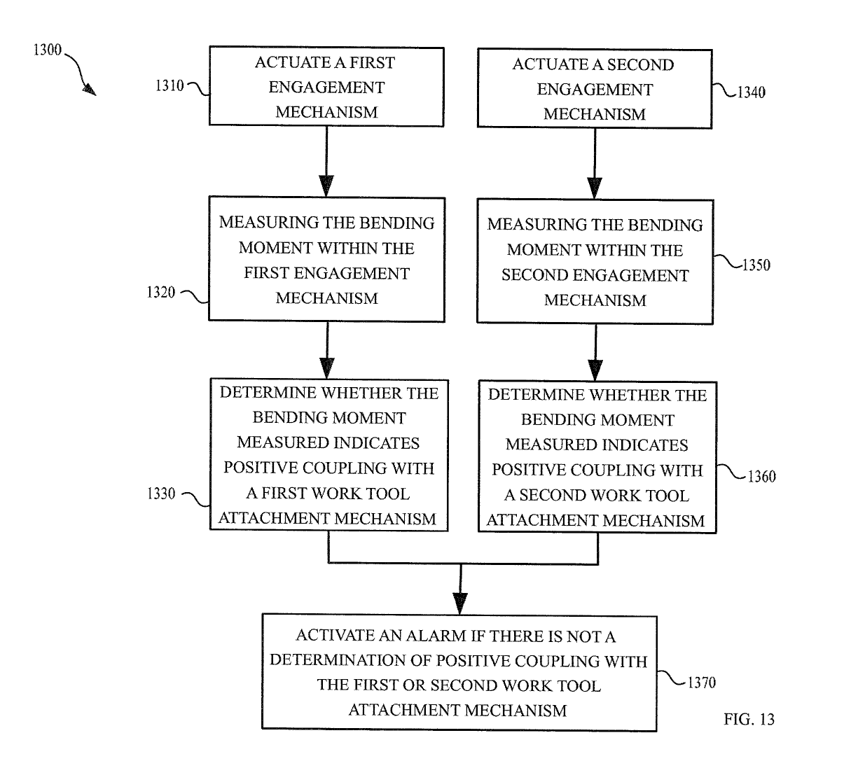

FIG. 13 is a flowchart of another exemplary method 1300 that may be used to detect positive coupling between an engagement system and a work tool accessory where two different engagement mechanisms couple with two different work tool attachment mechanisms. The exemplary method 1300 may involve actuating first engagement mechanism 1310 and actuating a second engagement mechanism 1340. The exemplary method may also involve measuring the strain within the first engagement mechanism 1320 and measuring a separate strain within the second engagement mechanism 1350. The strain may be a bending moment or axial moment within the first engagement mechanism. The exemplary method 1300 may also involve determining whether the value of the strain within the first engagement mechanism indicates positive coupling with a first work tool attachment mechanism 1330 and making a separate determination whether the value of the strain within the second engagement mechanism indicates positive coupling with a second work tool attachment mechanism 1360. The exemplary method may involve actuating an alarm if the strain does not indicate positive coupling between the first engagement mechanism and the first work tool attachment mechanism or positive coupling between the second engagement mechanism and the second work tool attachment mechanism 1370.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### INDUSTRIAL APPLICABILITY

The present disclosure is applicable to machines in the construction and mining fields where various work-tool accessories may be applied to the machine 100. Commonly excavators, backhoes, or loaders use a variety or work tools such as augers, buckets, hammers, forks, grapples, shovels, or other work tool accessories necessary to complete a certain task. Quick couplers 200, 900 are commonly used in the construction industry to allow the machine to interface with the variety of work tool accessories. Quick couplers 260, 900 may greatly expand the utility of a single machine. For example, a single excavator may be used for excavating dirt, rock and other material, and during the excavation operations different work tool accessories may be required, such as a different size of bucket, a hammer, or a grapple. The quick coupler 200 can be used to quickly change from one work tool accessory 160 to another while ensuring that the work tool accessory 160 is positively coupled to the stick member 140, thus reducing downtime for the machine 100 and ensuring that the machine 100 is safe to operate after switching between work tool accessories 160.

With the present disclosure if there is a miss-couple where the work tool accessory 160 fails to positively engage, the engagement mechanism 230 will not be under a strain and a false-positive will not be measured by the sensor in the engagement mechanism 230. The present disclosure also contemplates communication between a first sensor 233 in the engagement mechanism 230 and an engine control module of the machine 100 or another add-on central processing unit in the machine 100. After communication with the engine control module or add-on central processing unit a determination of positive coupling may be made and a warning message or alarm would sound if positive coupling is not present.

Measuring strain in the engagement mechanism 230 may be more accurate because only one variable must be measured and any calculation made to determine positive coupling between the quick coupler 200 and the work tool accessory 160 is not reliant on the diameter or other aspects of the work tool attachment mechanism 240 in the work tool accessory 160.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A quick coupler comprising:
a first engagement mechanism including a first sensor incorporated into the first engagement mechanism, wherein the first sensor detects a first strain within the first engagement mechanism caused by a first work tool attachment mechanism.

2. The quick coupler of claim 1, wherein the first engagement mechanism is a wedge that moves longitudinally between a recessed configuration proximate to the center of the quick coupler and an extended configuration distal to the center of the quick coupler.

3. The quick coupler of claim 2, wherein the first strain detected by the first sensor is a bending moment.

4. The quick coupler of claim 3, wherein the first sensor includes a first pair of gages and a second pair of gages.

5. The quick coupler of claim 4, wherein the first pair of gages includes a first gage and a second gage wherein the first gage is oriented perpendicular to the second gage, further wherein the second pair of gages includes a third gage and a fourth gage wherein the third gage is oriented perpendicular to the fourth gage.

6. The quick coupler of claim 4, wherein the first pair of gages includes a first gage and a second gage wherein the first gage is oriented parallel to the second gage, further wherein the second pair of gages includes a third gage and a fourth gage wherein the third gage is oriented parallel to the fourth gage.

7. The quick coupler of claim 2, wherein the first strain detected by the first sensor is an axial moment.

8. The quick coupler of claim 2, wherein the first sensor is in communication with an engine control module, and wherein the engine control module activates an alarm system when the strain measured by the first sensor is not above a first predetermined threshold value.

9. The quick coupler of claim 2, further comprising a second engagement mechanism including a second sensor incorporated into the second engagement mechanism, wherein the second sensor detects a second strain within the second engagement mechanism caused by a second work tool attachment mechanism.

10. The quick coupler of claim 9, wherein the second strain detected by the second sensor is a bending moment.

11. The quick coupler of claim 9, wherein the second strain detected by the second sensor is an axial moment.

12. A method of detecting work tool engagement comprising:
actuating a first engagement mechanism;
measuring a strain within the first engagement mechanism;
determining whether the strain measured in the first engagement mechanism indicates positive coupling with a first work tool attachment mechanism.

13. The method of claim 12, further comprising activating an alarm if there is not a determination of positive coupling with the first work tool attachment mechanism.

14. The method of claim 13, wherein the strain is a bending moment.

15. The method of claim 13, wherein the strain is an axial moment.

16. The method of claim 13, further comprising:
actuating a second engagement mechanism;
measuring a second strain within the second engagement mechanism;
determining whether the second strain measured in the second engagement mechanism indicates a positive coupling with a second work tool attachment mechanism.

17. The method of claim 16, further comprising activating the alarm if there is not a determination of positive coupling with the first work tool attachment mechanism.

18. The method of claim 17, wherein the second strain is a bending moment.

19. The method of claim 17, wherein the second strain is an axial moment.

20. A machine comprising:
a frame
a tool having a first attachment pin and a second attachment pin
a quick coupler capable of engaging the tool including:
a first engagement mechanism including a wedge capable of moving longitudinally between a recessed configuration proximate to the center of the quick coupler engagement system, and an extended configuration distal to the center of the quick coupler engagement system, wherein the wedge includes a first sensor enclosed in the wedge and capable of measuring the bending moment on the wedge in order to detect positive engagement with an first attachment pin of a work tool accessory;
wherein the first sensor is in communication with an engine control module capable of activating an alarm system if the bending moment measured by the first sensor does not indicate positive engagement with the first attachment pin of the work tool accessory; and
an operator display containing the alarm system.

21. A quick coupler comprising:
a first engagement mechanism including a first sensor incorporated into the first engagement mechanism, wherein the first sensor detects the proximity between the first engagement mechanism and a first work tool attachment mechanism, further wherein the first engagement mechanism is a wedge that moves longitudinally between a recessed configuration proximate to the center of the quick coupler and an extended configuration distal to the center of the quick coupler.
